(19) United States
(12) Patent Application Publication
(10) Pub. No.: US 2024/0367884 A1
(43) Pub. Date: Nov. 7, 2024

(54) ENERGY MANAGEMENT AND CONSERVATION WHILE ENSURING COLD-CHAIN COMPLIANCE WITHIN AN ACTIVE COOLING SYSTEM ("ACS") ARRAY OF ACTIVELY COOLED TOTES ("ACTS")

(71) Applicant: Phononic, Inc., Durham, NC (US)

(72) Inventors: Karen Benedek, Winchester, MA (US); Michael Canaday, Durham, NC (US); Michael Hash, Raleigh, NC (US); Ed Karwacki, Garner, NC (US)

(21) Appl. No.: 18/653,879

(22) Filed: May 2, 2024

Related U.S. Application Data
(60) Provisional application No. 63/499,597, filed on May 2, 2023.

(51) Int. Cl. B65D 81/38; B65D 81/18

(52) U.S. Cl. CPC B65D 81/3813; B65D 81/18

(57) ABSTRACT

Systems and methods for energy management and conservation while ensuring cold-chain compliance are provided. In some embodiments, a method of operating an Active Cooling System (ACS) includes: determining the operating needs of a plurality of Actively Cooled Totes (ACTs); and adjusting an operation of one or more of the plurality of ACTs based on a physical location of the one or more of the plurality of ACTs in the ACS. In this way, this can prevent mass turn-on of a cluster of ACTs physically close together, generating large columns of hot exhaust air. This can also enable energy savings and prioritization of energy usage.

### RELATED APPLICATIONS

This application claims the benefit of provisional patent application Ser. No. 63/499,597, filed May 2, 2023, the disclosure of which is hereby incorporated herein by reference in its entirety.

### FIELD OF THE DISCLOSURE

The disclosure relates generally to temperature-controlled environments.

### BACKGROUND

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck. Whether the truck has one gallon of milk or a pint of ice cream, the entire space must be cooled or frozen. Compressor based refer trucks and tri temp trucks or vans must be penetrated from the outside to get the cooling platform of a compressor-based system inside the truck or van, which voids the warranty of the van or truck. In addition, to run tri temperature trucks, dividers must exist between the temperature zones to maintain temperature. The separation of space requires separation of orders that have goods in two or more zones. Compressor based systems pull too much power for the system to be placed in or on a fully electric vehicle without degrading the range of the vehicle significantly. Improved systems and methods for thermal management are needed.

### SUMMARY

Systems and methods for energy management and conservation while ensuring cold-chain compliance are provided. In some embodiments, a method of operating an Active Cooling System (ACS) includes: determining the operating needs of a plurality of Actively Cooled Totes (ACTs); and adjusting an operation of one or more of the plurality of ACTs based on a physical location of the one or more of the plurality of ACTs in the ACS. In this way, this can prevent mass turn-on of a cluster of ACTs physically close together, generating large columns of hot exhaust air. This can also enable energy savings and prioritization of energy usage.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 illustrates an example of a tote as discussed herein;

FIGS. 6A and 6B illustrate that different versions of the totes could be used in refrigerator or freezer versions;

FIG. 7 shows an exploded view of the tote that includes a thermoelectric unit as discussed herein;

FIG. 8 shows the standard tri-temperature truck that is used for deliveries;

FIG. 9 illustrates a delivery truck which does not need refrigeration systems or needs less;

FIG. 10 illustrates airflow pattern between adjacent totes, according to some embodiments;

FIG. 11 illustrates bulk exhaust airflow in stack of totes, according to some embodiments;

FIG. 12 illustrates Placement of Actively Cooled Totes in Facility, according to some embodiments;

FIG. 13 illustrates an example Automated Storage & Retrieval System (ASRS) diagram, according to some embodiments;

FIG. 14 illustrates that a disposition can be based on power and network status of the ACS Connected Services, according to some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Last mile delivery of food requires temperature-controlled transport of perishable food items using transit vans or similar vehicles. For temperature control, refrigerated or freezer totes can be used which are installed in the van (e.g., a cargo van) or a box truck.

These totes use an active heat pump to pull heat from an enclosed chamber and reject it to surrounding ambient air. The hot air must be removed from the van to ensure optimum operation of the totes.

These totes require power while in transit maintain food safety requirements for perishable consumption. The electrical system needs to reach (and/or maintain) the correct temperature must be met for operation of the totes.

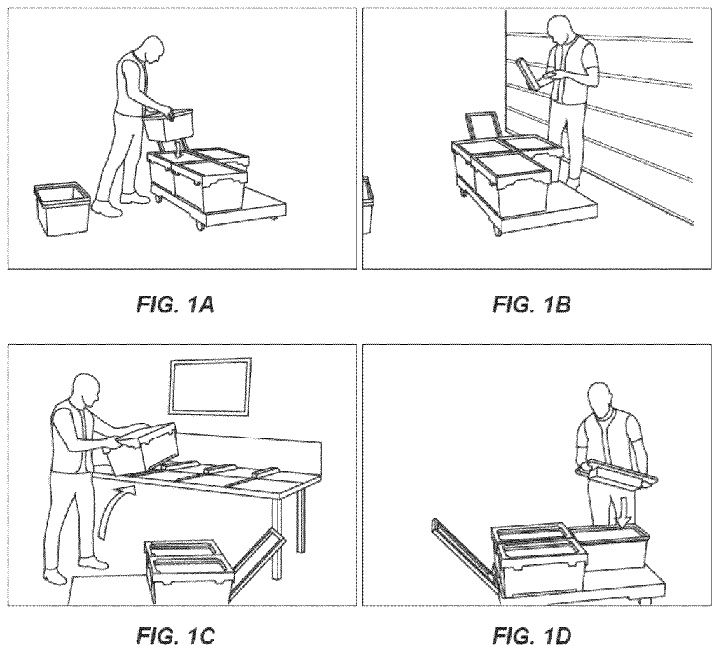

FIGS. 1A-1D illustrate utilization of a portable, self-contained, refrigeration or freezing system, coupled with integrated automated controls and monitoring.

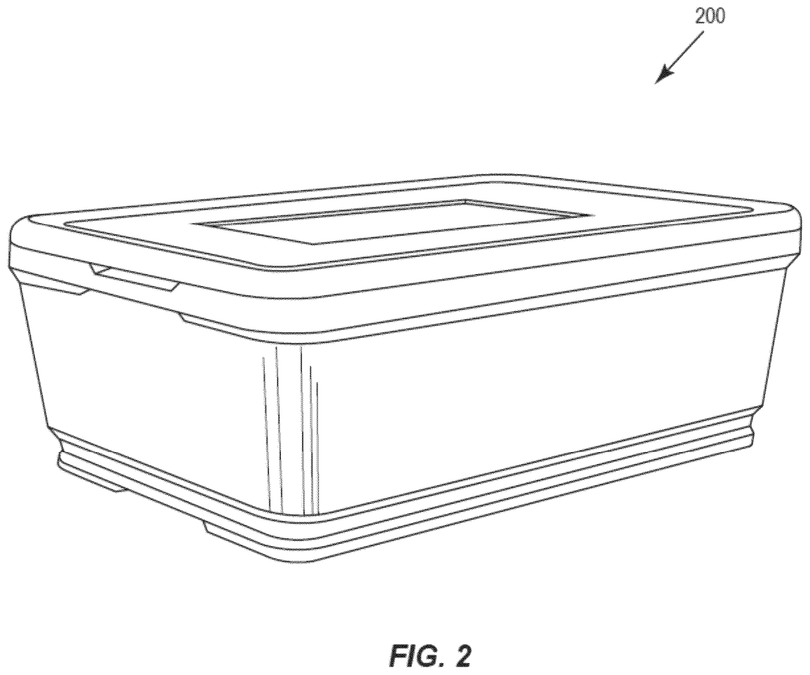

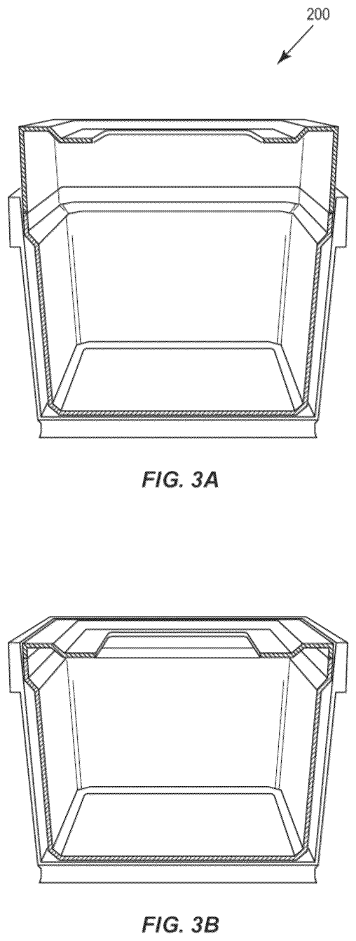

FIG. 2 and FIGS. 3A and 3B illustrate an example embodiment of an active cooler in accordance with embodiments of the present disclosure.

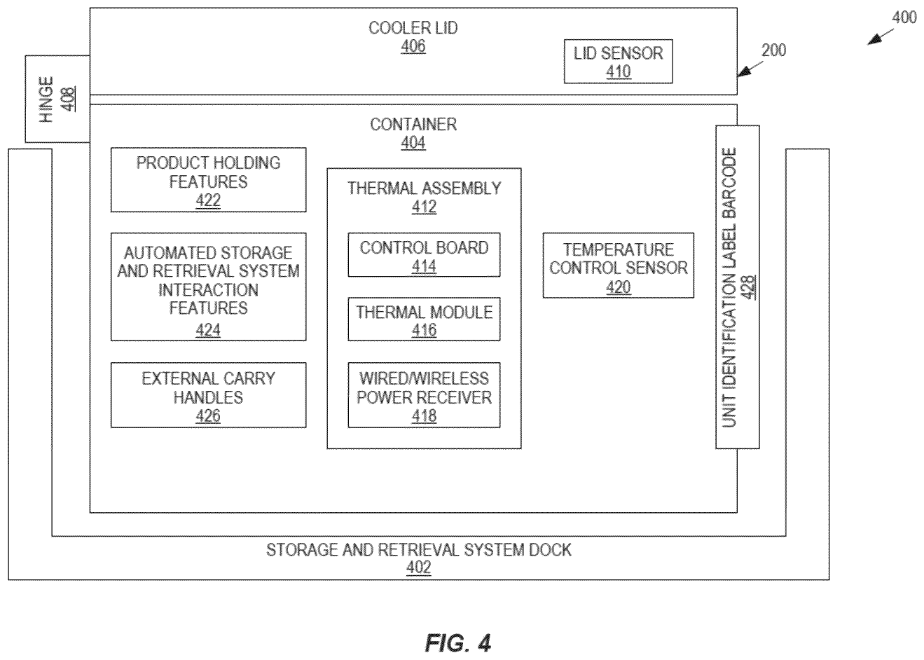

FIG. 4 illustrates a system including an active cooler in accordance with some embodiments of the present disclosure.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

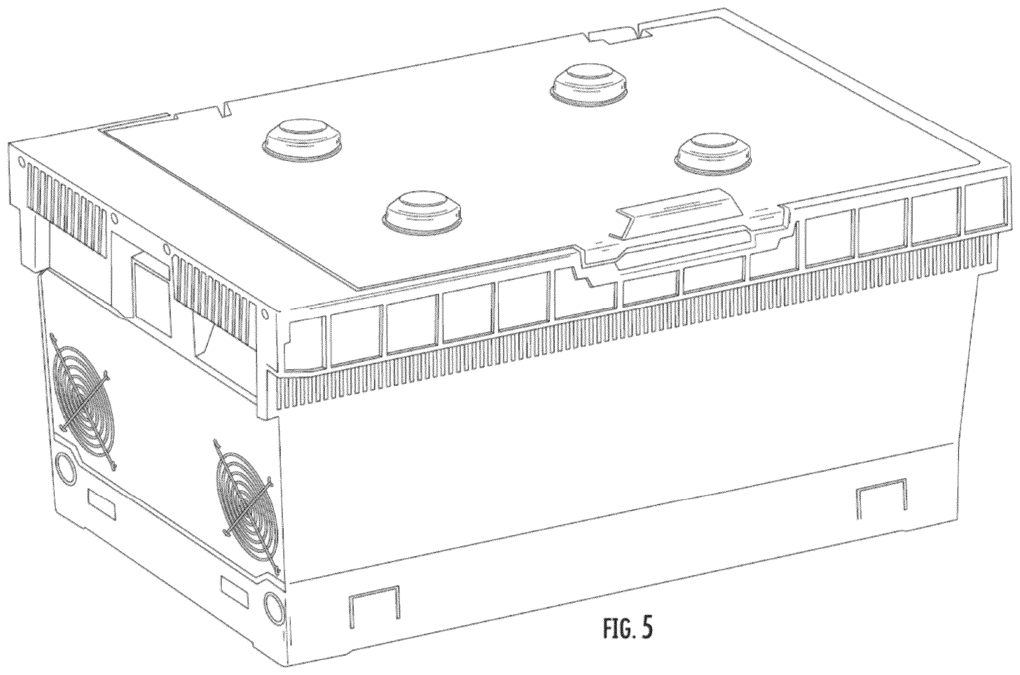

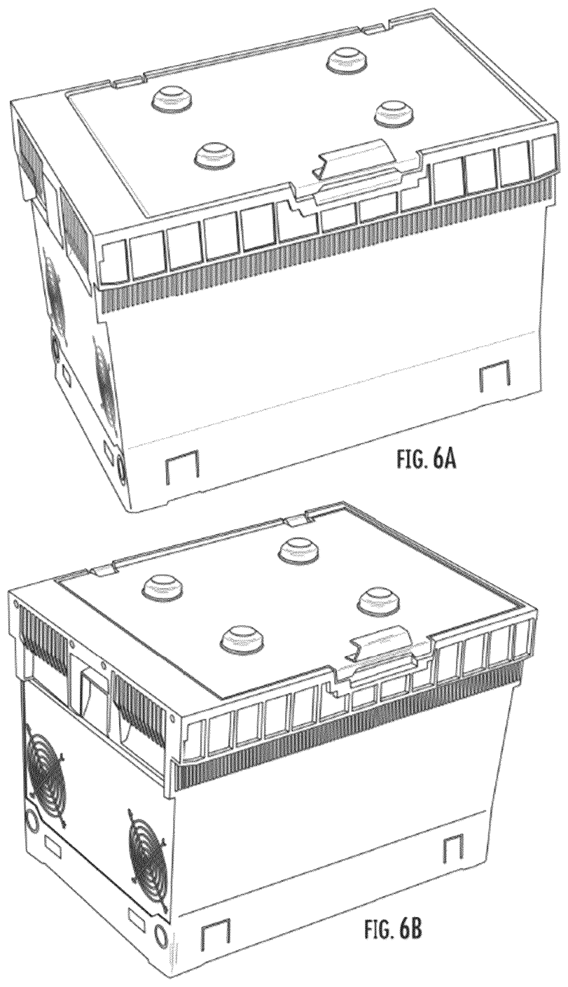

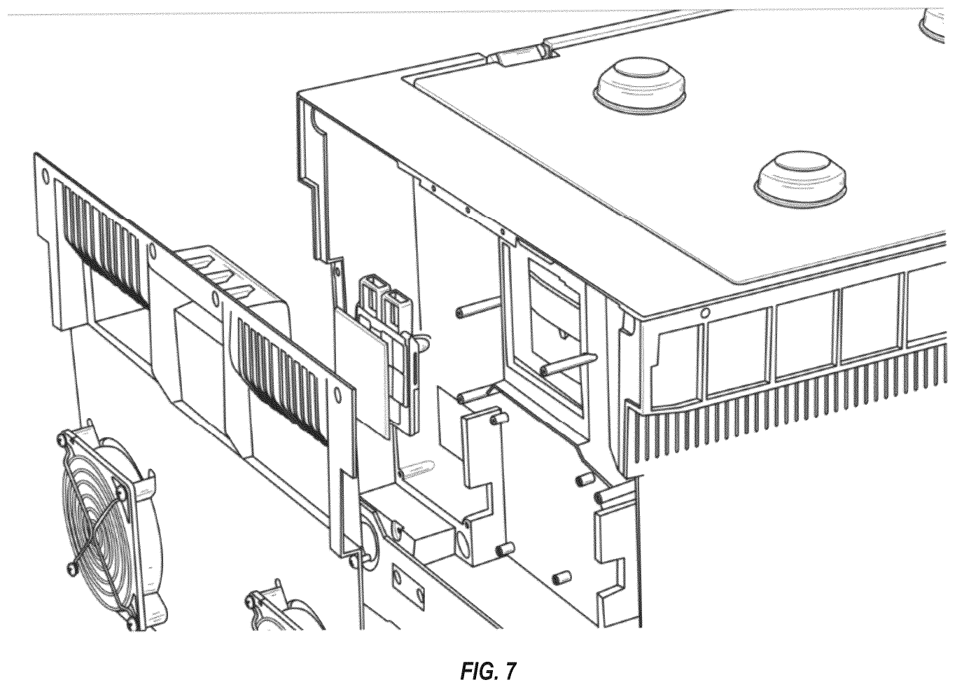

FIG. 5 illustrates an example of a tote as discussed herein. FIG. 6 illustrates that different versions of the totes could be used in refrigerator or freezer versions. FIG. 7 shows an exploded view of the tote that includes a thermoelectric unit as discussed herein.

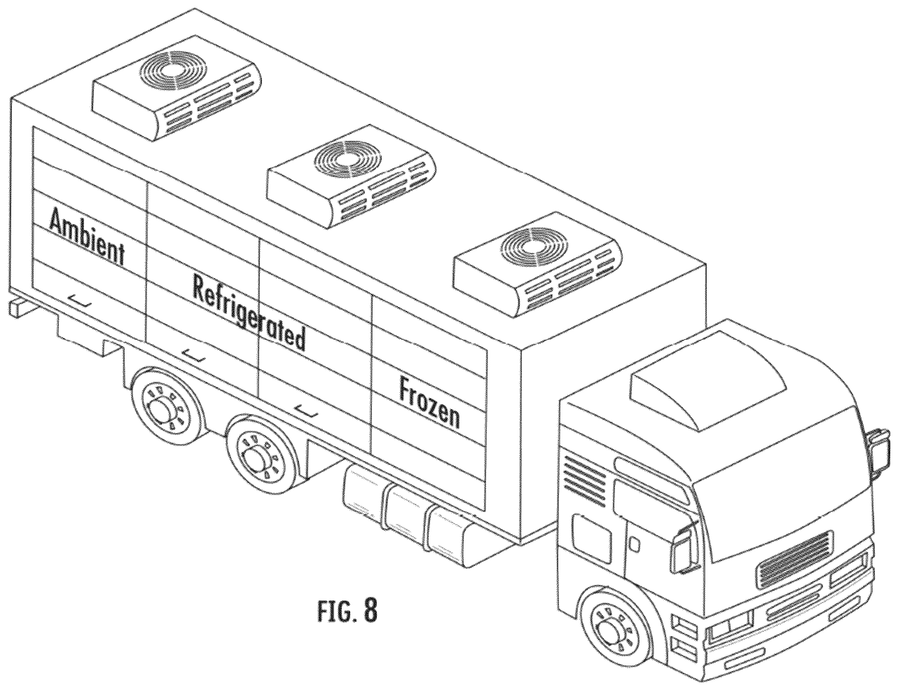

FIG. 8 shows the standard tri-temperature truck that is used for deliveries. This might include several different cooling systems that must be carried around regardless of whether they are currently needed.

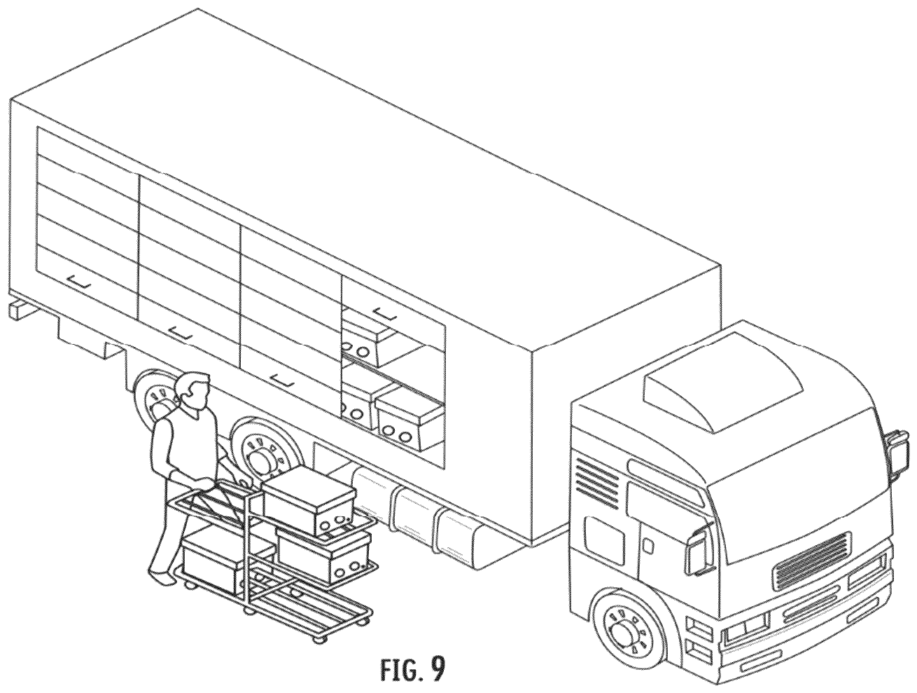

FIG. 9 illustrates a delivery truck which does not need refrigeration systems or needs less. In this embodiment, the totes provide the proper temperatures for the various goods. This can make the trucks more efficient in many ways. This also adds configurability. If an entire truck is needed for a specific temperature, this can be easily accomplished as opposed to the standard truck. These trucks might include charging capabilities or other amenities.

Re-entrainment (aka “re-breathing”) occurs when hot air exhausted from an actively cooled tote is trapped in space between adjacent totes and this exhaust air is then drawn back into the same tote from which it was exhausted.

The result of this re-entrainment is reduced performance of and excess energy consumption by the tote as it will require a continuous high-power operation of the thermoelectric system to cool to and maintain desired setpoint. In some cases of severe re-entrainment such as in higher-than-normal ambient temperature, it will reach its system limitation and be unable to reach the desired setpoint, settling at a higher than desired internal cooled temperature.

In addition to potential re-entrainment of exhaust air due to totes placed adjacently, the bulk exhaust airflow of numerous totes must also be addressed to prevent the performance degradation as described above.

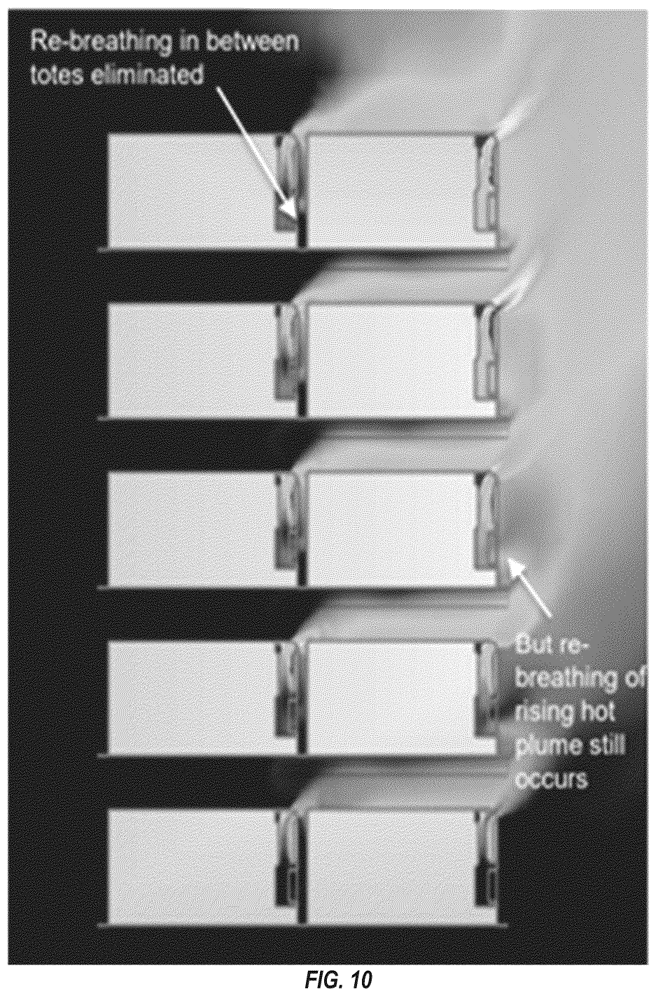

FIG. 10 illustrates airflow pattern between adjacent totes. In some embodiments, orientation of exhaust outlet on tote eliminates the re-entrainment problem between adjacent totes by directing hot exhaust air at an angle (approximately 45 degrees) over top of the adjacent tote.

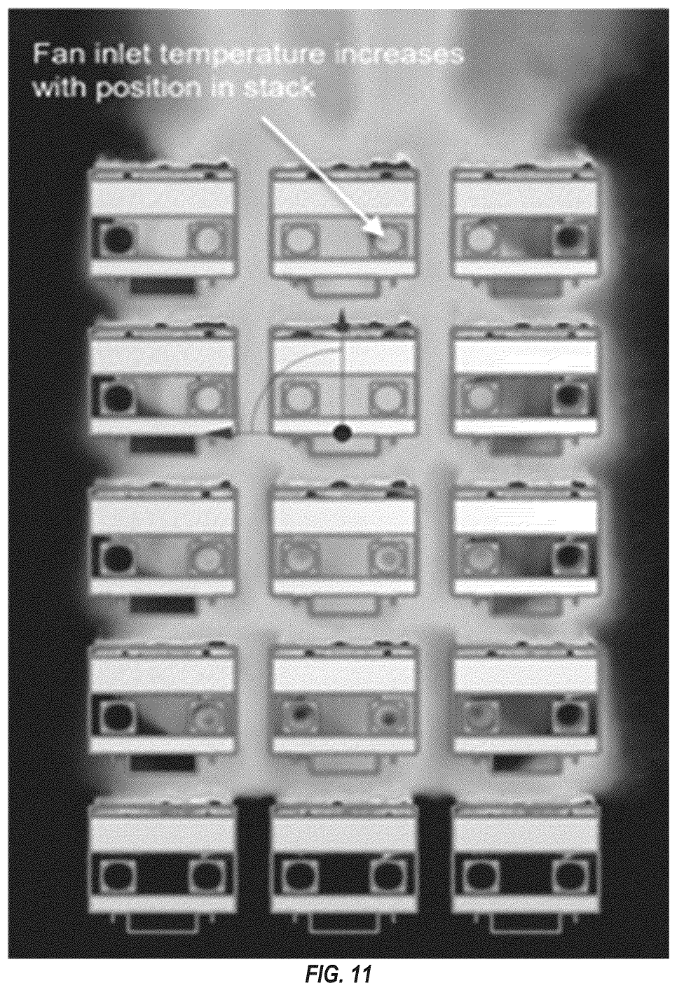

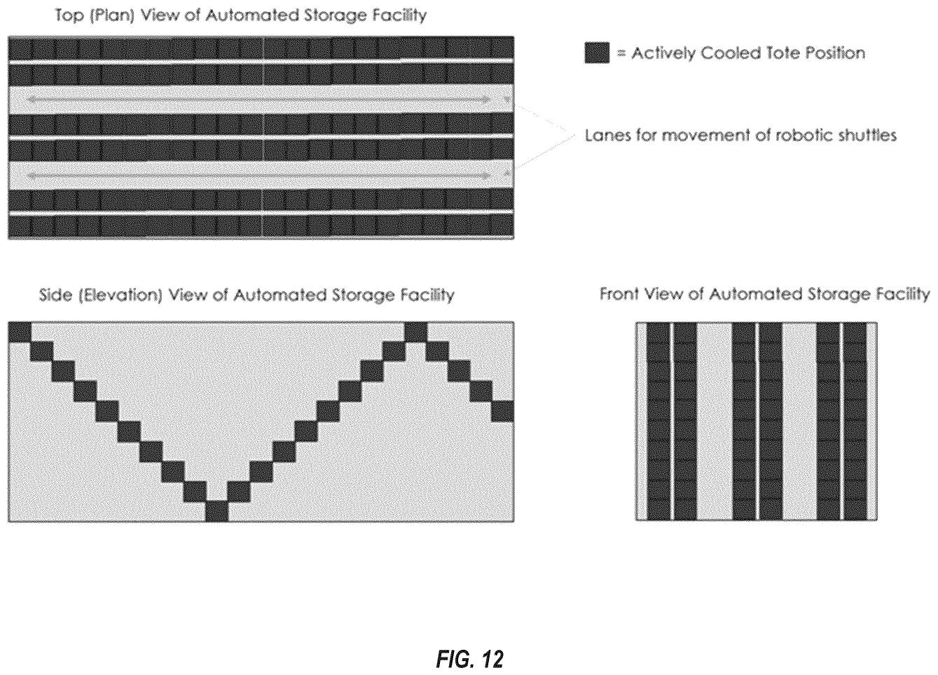

In some embodiments, bulk exhaust air is addressed by placement of the totes in the facility in a manner intentionally separating them to prevent a column of hot exhaust air (thermal plume) developing in a stack of totes. FIG. 11 illustrates bulk exhaust airflow in stack of totes. FIG. 12 illustrates Placement of Actively Cooled Totes in Facility, according to some embodiments. Building HVAC system will then handle and condition the exhaust air as normal. This configuration places actively cooled totes in a staggered pattern through the length of the facility, preventing hot exhaust air stacks while still allowing full utilization of the shuttle robots which retrieve and return the totes from the storage racks. Actively cooled totes comprise some percentage of all totes in the facility, with the other positions in the racks occupied by ambient totes which do not exhaust hot air.

### Problem “A”

Control of the turn-on and turn-off of the Actively Cooled Tote (ACT) array is critical to operation in general and is a fundamental principle guiding several specific embodiments for control of the Actively Cooled System. The basic principle is to balance, at any given point in time, the ACTs operating in pulldown-state (highest power consumption to cool quickly from ambient temperature) with ACTs at steady-state (less power consumption). This prevents mass turn-on of a cluster of ACTs physically close together, generating large columns of hot exhaust air. This event is likely to occur in large stacks of ACTs used for storage of frozen or refrigerated food items, typically in an Automated Storage & Retrieval System (ASRS). A mass turn-on event would create several problems: 1) current draw exceeding capacity of the building electrical distribution system 2) generation of large columns of hot exhaust air which reduce cooling efficiency and increase current draw and exhaust temperature—further compounding the problem.

### Summary of Solution “A”—Controlled Turn-On

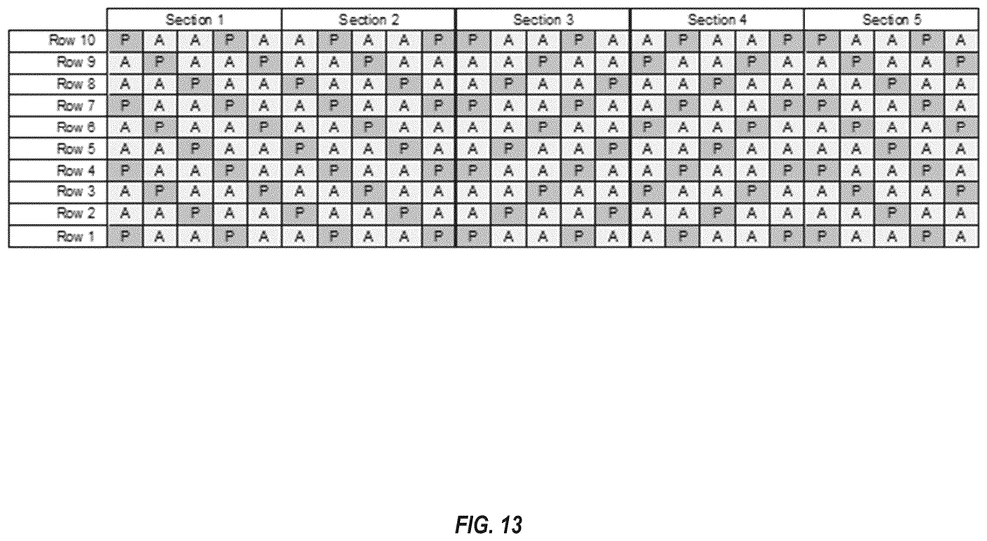

Turn on ACTs in an ordered method based on their location. Through integration with the ASRS inventory management system, the location of each ACT is known to the ACS Connected Services system. In the example ASRS diagram shown below (FIG. 13), Phononic Actively Cooled Totes are designated as “P” and non-active ambient totes are designated as “A”. In an example turn-on scenario, ACTs in sections 1, 3, and 5 could be turned on first. When this group of ACTs reaches steady-state and power draw reduces accordingly, the remaining ACTs in sections 2 and 4 could then be turned on.

### Problem “B”

In the event of a power outage at the facility, the entire array of ACTs in the system must return to operation upon restoration of power in a manner which avoids the concerns described in Problem “A”.

### Summary of Solution “B”—Controlled Power Outage Recovery

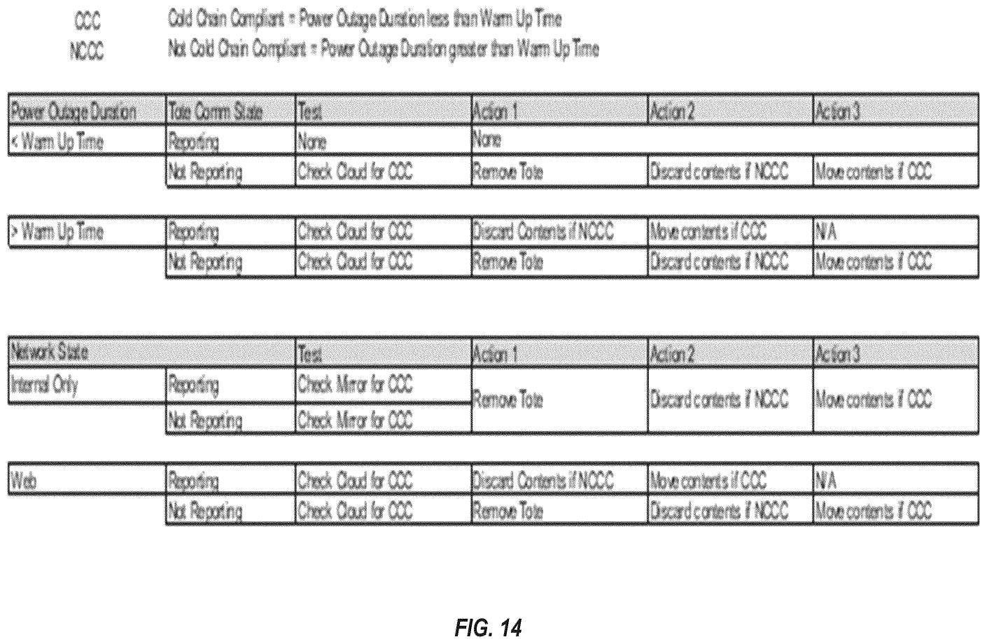

Upon return of power, a polling operation to determine current temperature of every ACT in the system could be used to prioritize turn-on order—ACTs that have warmed up the most while power was off will be turned on first. Additionally, cold-chain compliance of frozen or refrigerated food items stored in the ACTs must be verified, with proper disposition instructions provided to the users/operators of the system. Disposition is based on power and network status of the ACS Connected Services as described in the table in FIG. 14.

### Problem “C”

Optimization of the cooling profile in any given ACT is best performed with information in hand on whether the ACT is empty or containing food products, and how much food product is contained (% full). Without direct integration of the ACS with the inventory management system, this information must be gathered by other means. Additionally, direct sensing of load using mechanical/electrical sensors may not be cost effective or technically feasible.

### Summary of Solution “C”—Load Estimation by Inference

Load estimation by inference. By monitoring temperature profile of any given ACT, the approximate load % and item type can be estimated without requiring direct sensing or scanning of the items. This estimation is performed by comparing the temperature profile against a known set of profiles corresponding to known load % and item types (look-up table). In an alternate embodiment, this estimation is performed and refined by machine-learning instead of by table look-up. For example, the rate of temperature pulldown (cooling from ambient to setpoint temperature) will be affected by presence or absence of a food load, and in this implementation that known rate change can be used as a predictor of what is contained within the ACT.

### Problem “D”

Continuous operation of each ACT at its maximum cooling capability will cause unnecessarily large and wasteful energy consumption by the ACS overall.

### Summary of Solution “D”—Optimization of Cooling Profiles

During normal operation of the ACS, operating telemetry from each ACT is regularly reported and stored by the ACS Connected Services system. Optimization of the cooling profile for the array of ACTs via the Active Cooling System (ACS) Connected Services is desired to manage and conserve energy. This can be achieved by adjusting the temperature setpoint for each ACT based on its usage (empty or loaded) or adjustment of a group of ACTs in the array as required for a specific use case. For example, if a group of ACTs is allocated for storage of ice cream, the required temperature setpoint may be lower (to prevent melting) than that required for items with less temperature sensitivity. Increasing the setpoint for ACTs with less sensitive items will reduce overall energy consumption of the system.

Adjustment of setpoint provides a secondary benefit of optimizing the storage temperature for a given food item to ensure freshness and quality. This adjustment can be made manually using the Connected Services control panel (with a filter option available to identify ACTs of a certain type by their metadata), or by integration with the inventory management system whereby specified items will automatically trigger an adjustment when placed into the ACTs, or by machine-learning whereby images of the placed items are used to identify the product type and automatically adjust temperature setpoints accordingly. Additionally, notifications may be sent to system managers/operators and subscribed users if abnormal deviations from the temperature setpoint occur.

Those skilled in the art will recognize improvements and modifications to the preferred embodiments of the present disclosure. All such improvements and modifications are considered within the scope of the concepts disclosed herein.

What is claimed is:

1. A method of operating an Active Cooling System, ACS, the method comprising:
determining the operating needs of a plurality of Actively Cooled Totes, ACTs; and
adjusting an operation of one or more of the plurality of ACTs based on a physical location of the one or more of the plurality of ACTs in the ACS.

2. The method of claim 1 wherein adjusting the operation of the one or more of the plurality of ACTs comprises:
balancing a number of the ACTs operating in pulldown-state with a number of ACTs operating in steady-state.

3. The method of claim 1 wherein adjusting the operation of the one or more of the plurality of ACTs comprises:
turning on the one or more of the plurality of ACTs in an ordered method based on the physical location of the one or more of the plurality of ACTs in the ACS.

4. The method of claim 1 wherein adjusting the operation of the one or more of the plurality of ACTs comprises:
balancing a number of the ACTs operating in pulldown-state with a number of ACTs operating in steady-state.

5. The method of claim 1 wherein determining the operating needs of the plurality of ACTs comprises:
polling the ACTs to determine a current temperature.

6. The method of claim 5 wherein adjusting the operation of the one or more of the plurality of ACTs comprises:
prioritizing activation of the ACTs with the largest difference between the current temperature and a desired temperature.

7. The method of claim 1 wherein determining the operating needs of the plurality of ACTs comprises:
polling the ACTs to determine requirements of the goods in each of the ACTs.

8. The method of claim 7 wherein adjusting the operation of the one or more of the plurality of ACTs comprises:
prioritizing activation of the ACTs with more strict requirements of the goods in those ACTs.

9. The method of claim 1 wherein adjusting the operation of the one or more of the plurality of ACTs comprises:
adjusting the operation of the one or more of the plurality of ACTs based on a current percentage of occupancy of the ACTs.

10. The method of claim 7 wherein adjusting the operation of the one or more of the plurality of ACTs comprises:
deprioritizing activation of the ACTs that are empty.

11. The method of claim 1 wherein adjusting the operation of the one or more of the plurality of ACTs comprises:
adjusting a setpoint temperature of the one or more of the plurality of ACTs.

12. A controller for operating an Active Cooling System, ACS, the controller comprising at least one processor and a memory, the memory comprising instructions to cause the controller to:
determine the operating needs of a plurality of Actively Cooled Totes, ACTs; and
adjust an operation of one or more of the plurality of ACTs based on a physical location of the one or more of the plurality of ACTs in the ACS.

13. The controller of claim 12 wherein adjusting the operation of the one or more of the plurality of ACTs comprises being operable to:
balance a number of the ACTs operating in pulldown-state with a number of ACTs operating in steady-state.

14. The controller of claim 12 wherein adjusting the operation of the one or more of the plurality of ACTs comprises being operable to:
turn on the one or more of the plurality of ACTs in an ordered method based on the physical location of the one or more of the plurality of ACTs in the ACS.

15. The controller of claim 12 wherein adjusting the operation of the one or more of the plurality of ACTs comprises being operable to:
balance a number of the ACTs operating in pulldown-state with a number of ACTs operating in steady-state.

16. The controller of claim 12 wherein determining the operating needs of the plurality of ACTs comprises being operable to:
poll the ACTs to determine a current temperature.

17. The controller of claim 16 wherein adjusting the operation of the one or more of the plurality of ACTs comprises being operable to:
prioritize activation of the ACTs with the largest difference between the current temperature and a desired temperature.

18. The controller of claim 12 wherein determining the operating needs of the plurality of ACTs comprises being operable to:
poll the ACTs to determine requirements of the goods in each of the ACTs.

19. The controller of claim 18 wherein adjusting the operation of the one or more of the plurality of ACTs comprises being operable to:
prioritize activation of the ACTs with more strict requirements of the goods in those ACTs.

20. The controller of claim 12 wherein adjusting the operation of the one or more of the plurality of ACTs comprises being operable to:
adjust the operation of the one or more of the plurality of ACTs based on a current percentage of occupancy of the ACTs.

21. The controller of claim 20 wherein adjusting the operation of the one or more of the plurality of ACTs comprises being operable to:
deprioritize activation of the ACTs that are empty.

22. The controller of claim 12 wherein adjusting the operation of the one or more of the plurality of ACTs comprises being operable to:
adjust a setpoint temperature of the one or more of the plurality of ACTs.
